(19) United States
(12) Patent Application Publication
(10) Pub. No.: US 2015/0032609 A1
(43) Pub. Date: Jan. 29, 2015

(54) CORRELATION OF DATA SETS USING DETERMINED DATA TYPES

(71) Applicant: International Business Machines Corporation, Armonk, NY (US)

(72) Inventors: Tamer E. Abuelsaad, Somers, NY (US); Gregory J. Boss, Saginaw, MI (US); Craig M. Trim, Sylmar, CA (US)

(73) Assignee: International Business Machines Corporation, Armonk, NY (US)

(21) Appl. No.: 13/952,714

(22) Filed: Jul. 29, 2013

(51) Int. Cl. G06F 17/30; G06Q 20/10

(52) U.S. Cl. CPC G06F 17/3053; G06Q 20/102
USPC 705/40; 707/728

(57) ABSTRACT

A computer receives a data set and determines the data type of the column data within. The computer identifies a second data set with columns of the same data type. The computer compares the contents of the columns and the formatting of the contents to determine a score representative of the relevancy of the data sets to one another. Responsive to the score exceeding a threshold, the computer suggests the second data set to a user.

### FIELD OF THE INVENTION

The present invention relates generally to the field of data set correlation, and more particularly to correlating data sets using inferred abstract data types.

### BACKGROUND OF THE INVENTION

In computer programming, a data type is a classification identifying one of various types of data. The classification of a data type determines the possible values for that data type, the valid operations for values of that data type, the meaning of the data, and the way values of that data type can be stored. Examples of data types include integer and Boolean.

Tokenization is the process of breaking a stream of text into words, phrases, symbols, or other meaningful elements called tokens. The list of tokens becomes input for further processing such as parsing or text mining. Tokenization is useful both in linguistics (where it is a form of text segmentation), and in computer science, where it forms part of lexical analysis.

In the fields of computational linguistics and probability, an n-gram is a contiguous sequence of n items from a given sequence of text or speech. The items can be phonemes, syllables, letters, words or base pairs according to the application. The n-grams typically are collected from a text or speech corpus.

### SUMMARY

Embodiments of the present invention disclose a method, computer program product, and system for correlating data sets by receiving from a client computer system a first data set having one or more columns, each with column data, determining the data type of each column, identifying a second data set with a column of the same data type, comparing the column data of the columns with matching data types to determine a relevancy score, and, if the relevancy score exceeds a relevancy threshold, suggesting the data set to the user.

### BRIEF DESCRIPTION OF THE SEVERAL VIEWS OF THE DRAWINGS

FIG. 1 is a functional block diagram illustrating a distributed data processing environment, in accordance with an embodiment of the present invention.

FIG. 2 is a flowchart depicting operational steps of a storefront program, operating within the data processing environment of FIG. 1, for suggesting a data set, in accordance with an embodiment of the present invention.

FIG. 3 is a flowchart depicting operational steps of a column ID program, operating within the data processing environment of FIG. 1, for determining an abstract data type of a column, in accordance with an embodiment of the present invention.

FIG. 4 is a flowchart depicting operational steps of an embodiment of a portion of a column ID program for determining an abstract data type, in accordance with an embodiment of the present invention.

FIG. 5 is a flowchart depicting operational steps of a comparison program, operating within the data processing environment of FIG. 1, for comparing data sets, in accordance with an embodiment of the present invention.

FIG. 6 depicts an implementation of data set correlation, in accordance with an illustrative embodiment of the present invention.

FIG. 7 depicts an implementation of a pattern definition, in accordance with an illustrative embodiment of the present invention.

FIG. 8 depicts a block diagram of components of a server computer, within the data processing environment, executing the storefront program in accordance with an embodiment of the present invention.

### DETAILED DESCRIPTION

Embodiments of the present invention recognize that a user may buy, sell, exchange, and/or merge data with other data of like kind to form more complete collections of data. Embodiments of the present invention recognize that data of a particular type is valuable to buyers who have related data. Data comes in a variety of formats, from highly structured relational databases to low-complexity formats such as a series of character-separated values. Embodiments of the present invention recognize that users may possess data which is only a part of a whole, such as departments within a company all having data pertaining to the company's customer base, which may be more valuable if combined. Also recognized is that such data may be segmented into many parts scattered among many users and stored in many different formats, which hinders a user from identifying related data in the possession of other users. Embodiments of the present invention provide a method for determining a data type of data, comparing the data to other data, and suggesting data based on the comparison.

Embodiments of the present invention further provide a method for correlation of data sets using determined data types. In an embodiment, the method enables a user to upload a data set to a storefront program, which determines a data type, compares the data set to one or more other data sets, and suggests a data set to the user, the suggested data set being relevant to the uploaded data set.

A data set is a body of data in a logically-organized, computer-readable format (e.g., comma-separated or character-delineated values, a relational database, a data cube, or non-relational database) or in an unstructured but computer-readable format. A data set comprises at least one column. A column comprises column data, which is a series of one or more values (or entries), which may be semantically related, residing within the respective data set. Associated with the column may be a header. The header comprises header data that describe, label, or identify the abstract data type of the column data of the column with which the header is associated. A header may be associated with one or more columns. A column may have zero or more associated headers.

An Abstract Data Type (ADT) is a data type which identifies data with a semantically-valuable classification. For example, an ADT corresponding to a date of birth has more semantic value than a mere date, as it also conveys the significance of the date. An ADT may have particular conventions for formatting of data (“pattern definition”). Formatting conventions includes content conventions. Conventions may be strict, such as requiring that a social security number contains exactly nine numerals, or it may be more lenient, such as by allowing multiple valid delineators (e.g., no delineator, dashes, periods, or spaces) between number groups in a phone number. Examples of ADTs may include, inter alia, names, addresses, phone numbers, serial numbers, scientific measurements (such as distance, volume, temperature, etc.), or account numbers.

Embodiments of the present invention recognize that identifying data by an abstract data type enables more accurate comparisons. For example, comparing two integers comprising digits identical to one another would result in a high degree of similarity. However, identifying the first integer as a dollar amount and the second integer as a phone number enables a more accurate comparison, which results in a low degree of similarity.

Implementation of such embodiments may take a variety forms, and exemplary implementation details are discussed subsequently with reference to the Figures.

As will be appreciated by one skilled in the art, aspects of the present invention may be embodied as a system, method or computer program product. Accordingly, aspects of the present invention may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, aspects of the present invention may take the form of a computer program product embodied in one or more computer-readable medium(s) having computer readable program code/instructions embodied thereon.

Any combination of computer-readable media may be utilized. Computer-readable media may be a computer-readable signal medium or a computer-readable storage medium. A computer-readable storage medium may be, for example, but not limited to, an electronic, magnetic, optical, electromagnetic, infrared, or semiconductor system, apparatus, or device, or any suitable combination of the foregoing. More specific examples (a non-exhaustive list) of a computer-readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer-readable storage medium may be any tangible medium that can contain, or store a program for use by or in connection with an instruction execution system, apparatus, or device.

A computer-readable signal medium may include a propagated data signal with computer-readable program code embodied therein, for example, in baseband or as part of a carrier wave. Such a propagated signal may take any of a variety of forms, including, but not limited to, electro-magnetic, optical, or any suitable combination thereof. A computer-readable signal medium may be any computer-readable medium that is not a computer-readable storage medium and that can communicate, propagate, or transport a program for use by or in connection with an instruction execution system, apparatus, or device.

Program code embodied on a computer-readable medium may be transmitted using any appropriate medium, including but not limited to wireless, wireline, optical fiber cable, RF, etc., or any suitable combination of the foregoing.

Computer program code for carrying out operations for aspects of the present invention may be written in any combination of one or more programming languages, including an object oriented programming language such as Java®, Smalltalk, C++ or the like and conventional procedural programming languages, such as the “C” programming language or similar programming languages. The program code may execute entirely on a user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

Aspects of the present invention are described below with reference to flowchart illustrations and/or block diagrams of methods, apparatus (systems) and computer program products according to embodiments of the invention. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer-readable medium that can direct a computer, other programmable data processing apparatus, or other devices to function in a particular manner, such that the instructions stored in the computer-readable medium produce an article of manufacture including instructions which implement the function/act specified in the flowchart and/or block diagram block or blocks.

The computer program instructions may also be loaded onto a computer, other programmable data processing apparatus, or other devices to cause a series of operational steps to be performed on the computer, other programmable apparatus or other devices to produce a computer-implemented process such that the instructions which execute on the computer or other programmable apparatus provide processes for implementing the functions/acts specified in the flowchart and/or block diagram block or blocks.

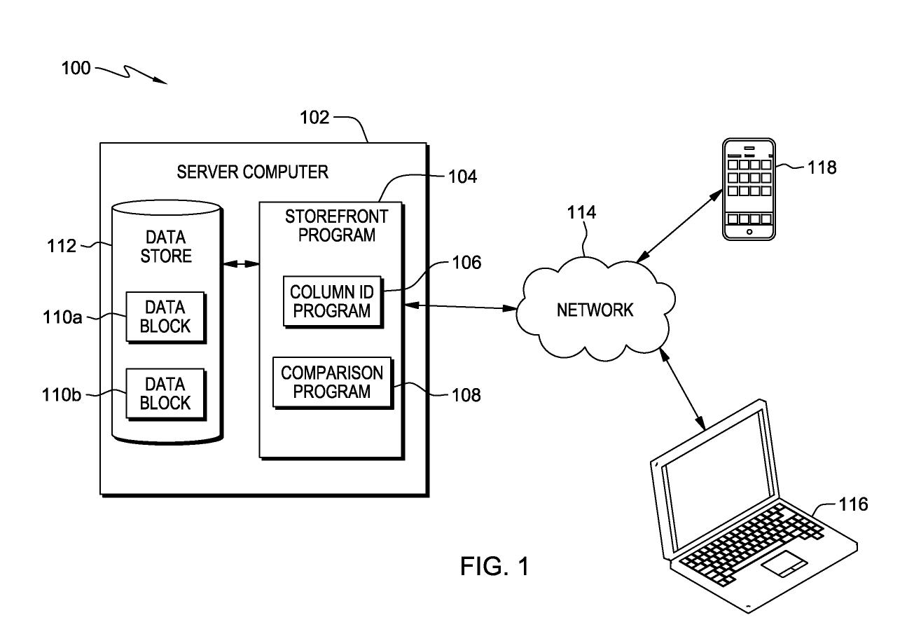

The present invention will now be described in detail with reference to the Figures. FIG. 1 is a functional block diagram illustrating a distributed data processing environment, generally designated 100, in accordance with one embodiment of the present invention.

Distributed data processing environment 100 includes server computer 102 and client devices 116 and 118, all interconnected over network 114.

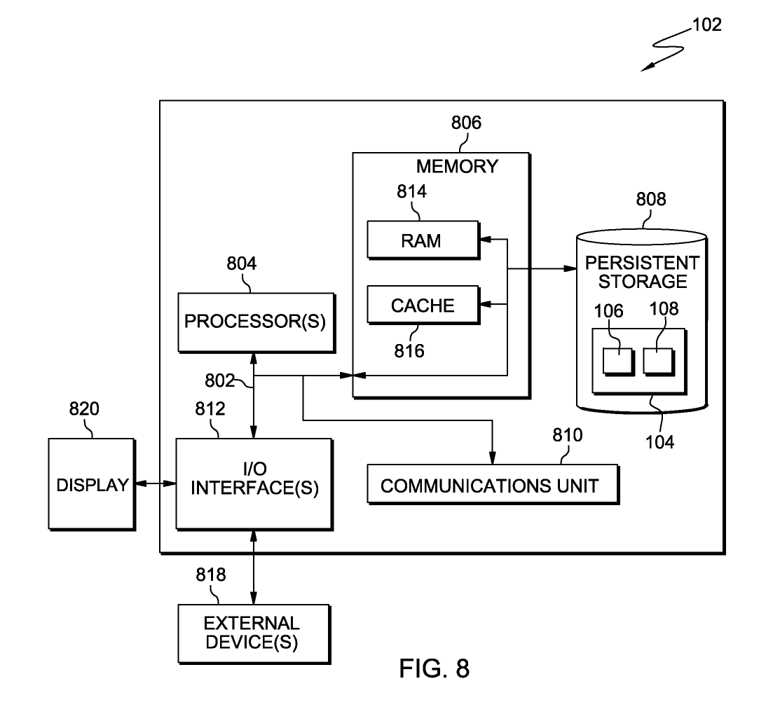

Server computer 102 may be a desktop computer, a laptop computer, a tablet computer, a specialized computer server, a smartphone, or any programmable electronic device capable of communicating with client devices 116 and 118 via network 114. In certain embodiments, server computer 102 represents a computer system utilizing clustered computers and components that act as a single pool of seamless resources when accessed through network 114, as is common in data centers and with cloud computing applications. In general, server computer 102 is representative of any programmable electronic device or combination of programmable electronic devices capable of executing machine-readable program instructions and communicating with other computing devices via a network. Server computer 102 may include internal and external hardware components, and exemplary components of server computer 102 are described in greater detail with regard to FIG. 8.

Various embodiments of the present invention, operating on server computer 102, use a variety of semantic analysis techniques, including tokenization, synonym analysis, acronym expansion, and n-gram analysis, which may be used separately or in combination.

In various embodiments of the present invention, client devices 116 and 118 can each respectively be a laptop computer, a tablet computer, a netbook computer, a personal computer (PC), a desktop computer, a personal digital assistant (PDA), a smartphone, or any programmable electronic device capable of communicating with server computer 102 via network 114. Client devices 116 and 118 may be capable of communicating with one another via network 114, as is common in peer-to-peer environments (e.g., to send or receive data sets). Client devices 116 and 118 may include an application capable of facilitating communication with server computer 102 (e.g., a web browser).

In general, network 114 can be any combination of connections and protocols that will support communications between server computer 102 and client devices 116 and 118. Network 114 can include, for example, a local area network (LAN), a wide area network (WAN) such as the internet, a cellular network, or any combination of the preceding, and can further include wired, wireless, and/or fiber optic connections.

Server computer 102 includes data store 112. In an alternate embodiment, data store 112 is independent from server computer 102. In such an embodiment, data store 112 may be an independent computer system utilizing clustered computers and components that act as a single pool of seamless resources when accessed through network 114, as is common in data centers and with cloud computing applications. Data store 112 may also be any suitable volatile or non-volatile computer-readable storage media.

In an embodiment, data store 112 stores first data set 110a and second data set 110b. Storefront program 104 may receive one or more data sets from a client device, e.g. client device 116 or 118. Storefront program 104 may write one or more data sets to data store 112.

It is understood that, when a data set is said to be sent or received, such as from storefront program 104 to column ID program 106, it may instead be a sent by reference, meaning that a reference, memory location (e.g., a pointer), filename, or other identifier corresponding to the data set is sent or received rather than the entire data set.

Storefront program 104 resides on server computer 102, determines a data type of column data, compares a data set against a second data set, and determines whether to suggest a data set to a user. In one embodiment, server computer 102 is a server system accessible to one or more users, e.g. the respective users of client devices 116 and 118, and storefront program 104 is a server application processing and suggesting data sets, e.g. data sets 110a and 110b residing on data store 112. In an alternate embodiment, storefront program 104 further comprises a client application residing on one or more client devices, such as client devices 116 and 118, in which case the client application is capable of communicating with server computer 102 through the network 114.

Storefront program 104 includes column ID program 106 and comparison program 108. In one embodiment, column ID program 106 and comparison program 108 are each a function, or subroutine, of storefront program 104. In another embodiment, one or both of column ID program 106 and comparison program 108 are independent of storefront program 104.

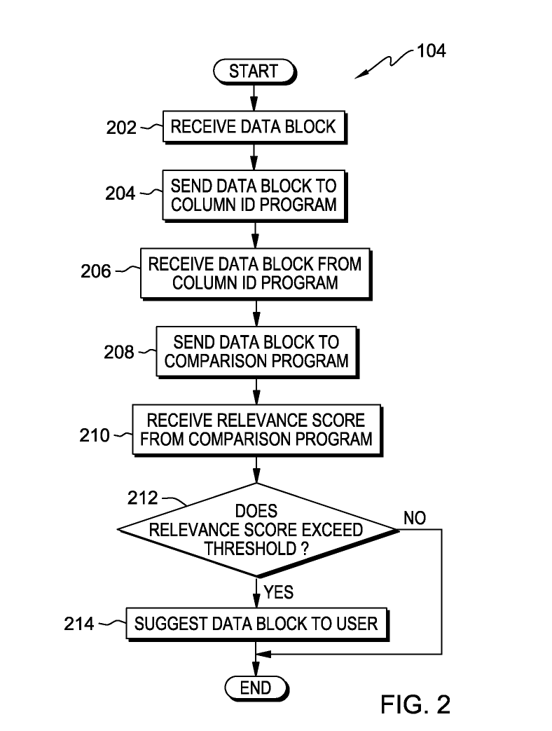

Storefront program 104 receives a data set by, for example, retrieving the data set from data store 112. The data set comprises a column. The storefront program 104 sends the data set to column ID program 106 and receives the data set modified to identify the data type of the column data. Storefront program 104 sends the data set to comparison program 108 and receives a relevancy score from comparison program 108. Storefront program 104 compares the relevancy score to a threshold to determine whether to suggest a data set to the user of a client device. Storefront program 104 is discussed in more detail in connection with FIG. 2.

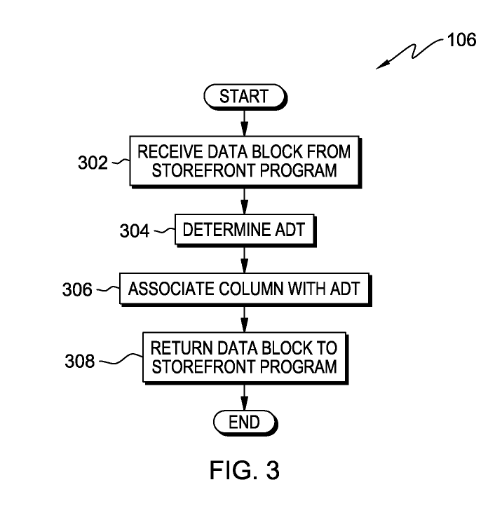

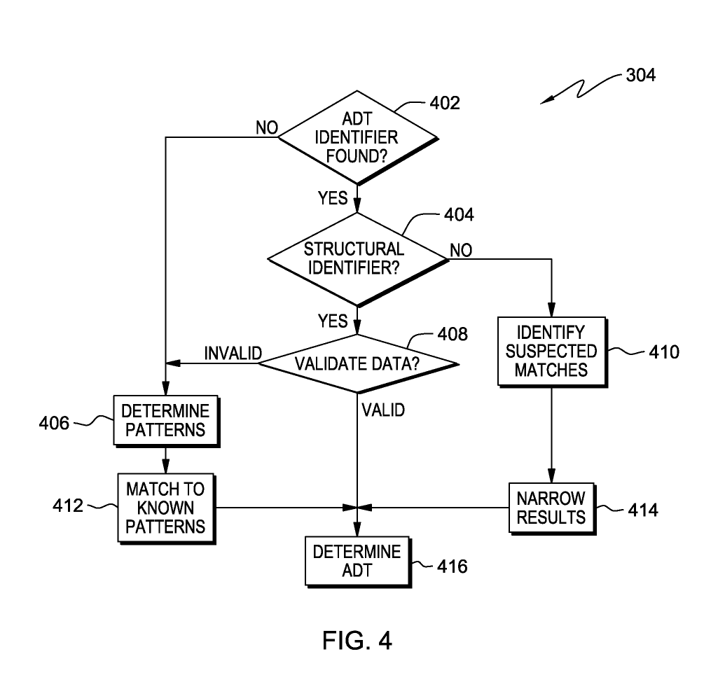

Column ID program 106 receives a data set from storefront program 104, parses the column data of a column to determine an ADT of the column data, modifies the data set to associate the column with the ADT, and returns the data set (as modified) to storefront program 104. Column ID program 106 is discussed in more detail in connection with FIGS. 3-4.

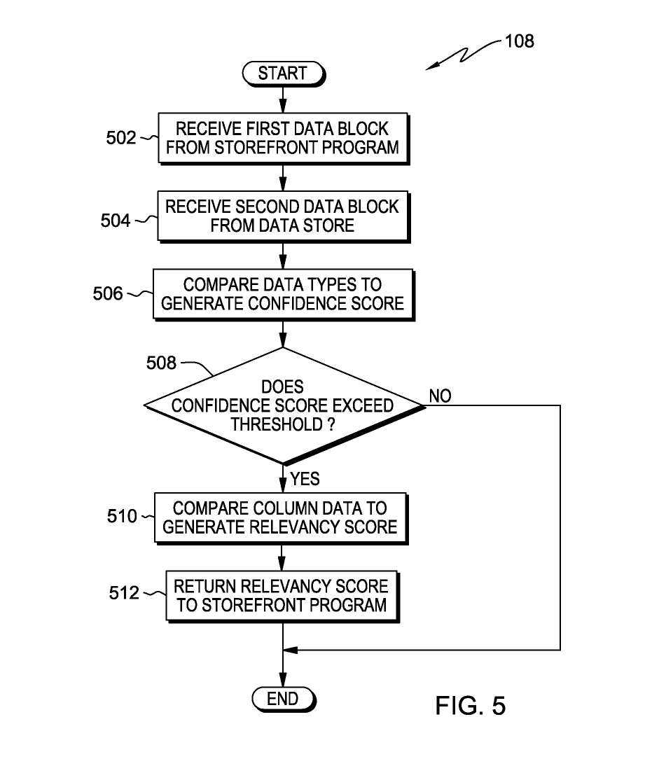

Comparison program 108 receives a first data set from storefront program 104 and compares the first data set to the second data set to generate a relevancy score. Comparison program 108 sends the relevancy score to storefront program 104. In one embodiment, comparison program 108 also sends a data set to storefront program 104. Comparison program 108 is discussed in more detail in connection with FIG. 5.

Storefront program 104 may use the relevancy score to determine a data set to suggest to a user. In an alternate embodiment, storefront program 104 may use the relevancy score in the determination of a purchase price of a data set. For example, a highly relevant data set may command a higher sale price than one with low relevance.

In an embodiment, each client device (e.g., client devices 116 and 118) includes an inventory list, the inventory list identifying a data set and an ADT of the data contained therein. The inventory list may be associated with a plurality of users. Multiple inventory lists may be compiled to form a master inventory list. In an alternate embodiment, the inventory list may reside in storefront program 104 or in data store 112, independent of storefront program 104.

In the embodiment, storefront program 104 compares a data set identified on the inventory list of a first client device (e.g., client device 116) to one or more other data sets residing in data store 112 or identified on the inventory list of a second client device (e.g., client device 118). Storefront program 104 may suggest a relevant data set to the user based on a determination that the relevant data set is relevant to one or more data sets identified on the inventory list of the user or otherwise owned by or associated with the user. For example, storefront program 104 may identify a first data set owned by a first user and highly relevant to a second data set owned by a second user, in which case storefront program 104 may suggest the first data set to the second user and may suggest the second data set to the first user by notifying each user of the respective data sets.

Storefront program 104 may allow peer-to-peer transactions such as selling, lending, or trading. Storefront program 104 may charge a fee to a user, which may be a flat fee, a percentage, or a combination. For example, the fee may be a flat fee for listing a data set for sale, a percentage of a sale price, or a flat fee for a trade. For example, storefront program 104 may receive a data set from a first user, determine the ADTs of its data, compare it to other data sets listed for sale by other users, and may suggest one of the listed data sets as relevant. If storefront program 104 receives user input accepting the sale price for the listed data set, storefront program 104 processes the sale transaction and may allocate a portion of the sale price to the owner of the purchased data set or sets. The owner may receive the allocated portion as a payment of funds, as a credit for use in storefront program 104, or in another form.

FIG. 2 depicts operational steps of storefront program 104 for correlating data sets using determined data types, in accordance with an embodiment of the present invention.

A data set comprises a column having column data, and the data set may comprise a header associated with the column, the header having header data. The data set may comprise a plurality of columns, each having an associated header, in which case storefront program 104 may perform the operational steps on each column.

Storefront program 104 receives a data set (step 202). Storefront program 104 may receive the data set responsive to storefront program 104 requesting or retrieving the data set from data store 112.

In an alternate embodiment, storefront program 104 may receive a data set (step 202) as user input from a client device, such as by upload from client device 116 to storefront program 104 via network 114. The uploaded data set may be stored in data store 112 either before, after, or concurrently with storefront program 104 receiving the data set.

In an alternate embodiment, storefront program 104 indexes a data set of a user without storing a copy in data store 112. For example, storefront program 104 the data set may stream over network 114 to storefront program 104 for indexing or a client device may include a client application capable of indexing the data set on the client device. Indexing comprises parsing the columns of a data set and storing the determined ADT metadata independently of, but associated with, the data set. Storefront program 104 may make suggestions based on a data set of a user without making the data set available for comparisons by other users.

Storefront program 104 sends the data set to column ID program 106 (step 204), which parses column data of a column of the data set, determines an ADT based on the column data, and annotates metadata to the data set, the metadata associating the column with the determined ADT.

Storefront program 104 receives the data set with metadata from column ID program 106 (step 206). The data set with metadata comprises metadata identifying the determined data type of each column of the annotated data set. Column ID program 106 is discussed more fully in connection with FIGS. 3 and 4.

Storefront program 104 sends the annotated data set to comparison program 108 (step 208), which compares the annotated data set with a second data set to generate a relevancy score.

Comparison program 108 compares the annotated data set against one or more other data sets. The relevancy score may be a measure of the similarity of the annotated data set to the other one or more data sets. In an alternate embodiment of step 208, storefront program 104 may also send one or more other data sets, concurrently or sequentially, to comparison program 108 for comparison to the annotated data set.

Storefront program 104 receives a relevancy score from comparison program 108 (step 210). In an alternate embodiment of step 210, storefront program also receives a data set from the comparison program. Comparison program 108 and the relevancy score are discussed more fully in connection with FIG. 5.

Storefront program 104 determines if the relevancy score exceeds a threshold (decision 212). The threshold may be known or may be received as input from a user. The threshold may be fixed or variable. In an embodiment, the threshold varies depending upon the type of data contained in the columns being compared.

If the relevancy score exceeds the threshold (decision 212), then storefront program 104 suggests a data set to the user (step 214). Storefront program 104 may suggest a data set to a user by, for example, presenting the user with a relevancy score, sending the data set to a client device, presenting all or part of the column data of the data set, or presenting other information relating to the data set, such as the ADTs of the data contained within the data set. The data set suggested to the user (step 214) may be the data set sent to the comparison program (step 208), the data set received from the comparison program (step 210), or another data set.

In an embodiment, the threshold may increase (or decrease) if the relevancy score exceeds (or fails to exceed) the threshold, which increases (or decreases) the selectivity of the threshold for future comparisons. In an alternate embodiment, storefront program 104 may increase or decrease the threshold responsive to the frequency of occurrences of the relevancy score exceeding the threshold (yes branch, decision 212) and/or failing to exceed the threshold (no branch, decision 212), which may be used to ensure a certain quota of each decision result.

FIG. 3 depicts operational steps of column ID program 106 for determining an abstract data type of a column, in accordance with an embodiment of the present invention.

Column ID program 106 receives a data set from storefront program 104 (step 302). A data set comprises a column having column data, and the data set may comprise a header associated with the column, the header having header data. The data set may comprise a plurality of columns, each having an associated header, in which case column ID program 106 may perform the operational steps on each column.

Column ID program 106 parses the column data of the column (step 304) to determine the data type of the column data. Column ID program 106 may use one or more methods, alone or in combination, to parse the column data (step 304). An exemplary embodiment including some such methods is discussed in more detail in connection with FIG. 4.

Column ID program 106 associates the column with the ADT (step 306) by metadata associating the column with the data type determined in step 304. Column ID program 106 may modify the data set with metadata in a variety of ways, such as by editing data set 110a (such as by creating a header, or editing a header if one already exists), and/or by creating an annotation associated with, but otherwise independent of, the column and the header (if any).

An exemplary embodiment recognizes that metadata associating column data with an ADT increases the semantic value of column data, thereby increasing the value of any comparisons made between the data set and another data set. According to this example, column data within a data set comprises groupings of seven characters. Column ID program 106 parses the column data and determines that the groupings are phone numbers. Column ID program 106 modifies the data set with metadata associating the column with an ADT corresponding to phone numbers.

If a column contains multiple data types, column ID program 106 may determine that the column contains a least generic applicable data type. For example, if the column contains both days of the week and names of states, the data type of the column may be determined to be an ADT corresponding to dictionary words. Alternatively, the column ID program 106 may match the column with multiple ADTs by grouping entries with patterns in common, in which case the column ID program 106 may group the entries logically or by rearranging them within the column data. If there is no detectible pattern to the column data, column ID program 106 may associate the column with an ADT corresponding to unknown data or raw data.

A data set may comprise a plurality of columns, in which case column ID program 106 performs steps 304 and 306 for each of the plurality of columns, which may be iterative, concurrent, or in parallel.

Column ID program 106 returns an annotated data set to storefront program 104 (step 308). The annotated data set comprises metadata associating each column with an ADT.

FIG. 4 depicts one implementation of step 304 of column ID program 106 for determining an ADT of a column, in accordance with an embodiment of the present invention. In this exemplary embodiment, the column has column data comprising entries and the column may be associated with a header having header data. In the described embodiment, multiple methods of determining an ADT of a column are combined, but it is understood that the methods described herein, and others, may be used individually or in combination.

Column ID program 106 determines whether an ADT identifier is associated with the column (decision 402), which would indicate the ADT of the column. The ADT identifier may reside in the header data, one or more of the entities, a data structure (for example, in a relational database), or may otherwise be associated with the column.

There may be no ADT identifier associated with the column (NO branch, decision 402), in which case the column ID program inspects the column data to determine the formatting patterns followed by the entries (step 406). Formatting patterns may include the number of characters, the type of characters (e.g., numeric, alphabetical, non-printing), the use and spacing of delineations (e.g., spaces, parentheses, dashes), and other characteristics. Formatting patterns may also include the use of terms which are related or of a single category, for example, names of cities, cardinal and/or ordinal directions, or species of plants.

Column ID program 106 matches the formatting patterns of the column data to known patterns of ADTs (step 412). The column data may include entries with different formats. For example, column data may include entries of “1-123-456-7890” and “1 (123) 456-7890.” Despite the differences in formatting, both comply with the formatting conventions of an ADT corresponding to phone numbers. An exact match between column data and an ADT occurs where all entries comply with the ADT pattern definition of only one ADT.

The patterns followed by the column data may result in multiple possible ADT determinations. For example, an entry of “123456789” may match a number of ADT pattern definitions of multiple ADTs, for example those corresponding to routing numbers and to social security numbers. Additional context may disambiguate multiple possibilities, aiding in ADT determination.

Column ID program 106 may use tokenization on entries of column data to detect patterns within portions of the entries, such as when an entry contains a triplestore (or an “is a” pattern).

For example, an entry of “the routing number is 123456789” may be broken into tokens, including “routing number” and “123456789.” The former token contains a semantic match to the name of an ADT corresponding to a routing number, and the contents of the latter follow the pattern definition of an ADT of the named type. The latter token, taken alone, would be ambiguous (for example, with a social security number), but the former token provides context, strengthening a determination that the entry contains a routing number.

Column ID program 106 may also use tokenization to detect other patterns. Using a semantic model (e.g., an ontology), recognition of a pattern followed by a token enables predicting the patterns followed by surrounding tokens. For example, a token of “(800)” is recognizable as an area code, which predicts that the surrounding tokens form the remainder of a phone number. This prediction can corroborate a match when the data uses valid, but uncommon, formatting, such as representing the digits of a phone number using a word. If the surrounding tokens do not correspond to a phone number, then it is unlikely that the entry is of an ADT corresponding to a phone number.

If there is an ADT identifier associated with the column (YES branch, decision 402), then column ID program 106 determines if the ADT identifier is a structural identifier (decision 404). A structural ADT identifier is one which resides in or is encoded within the data structure of the data set. For example, the data set may include data structures associated with each column or each element of each column describing the data, such as in a relational database. Column ID program 106 determines the ADT identifier to be structural if it is an ADT known to the column ID program (YES branch, decision 404). Alternatively, column ID program 106 may determine an ADT identifier to be structural even if it is unknown to column ID program 106 if, for example, the ADT identifier also defines the ADT pattern definition of the identified ADT, in which case column ID program 106 may integrate the definition of the identified ADT into the list of known ADTs.

If the ADT identifier is structural (YES branch, decision 404), then column ID program 106 determines whether the column data confirms to the ADT pattern definition of the identified ADT (decision 408).

For each entry of the column data, column ID program 106 determines if the formatting pattern followed by entry comply with the ADT pattern definition of the identified ADT. Column ID program 106 determines that the ADT identifier is invalid depending upon the number of entries which violate the ADT pattern definition (decision 408). For example, column ID program 106 may set a threshold at 75% compliance, in which case, if fewer than 75% of the entries are complaint, then the ADT identifier not validated. If the ADT identifier is invalid (INVALID branch, decision 408), then column ID program may determine the ADT based on the column data (step 406).

If column ID program 106 validates the ADT identifier (VALID branch, decision 408), then the determined column data type (step 416) is the ADT identified by the ADT identifier.

An ADT identifier which is not structural (NO branch, decision 404) may be, for example, text residing in or associated with the column data. For example, unstructured data may include text identifying data without meeting the formalities of more formal data structures. Alternatively, a non-structural identifier may be one residing in a data structure but which is unknown to column ID program 106, meaning that the ADT pattern definition of the identifier are not defined (which prevents validation by step 408).

Column ID program 106 identifies suspected matches to the ADT identifier (step 410) by comparing the ADT identifier to the names of known ADTs using, for example, tokenization and semantic analysis. Column ID program 106 may also use semantic analysis and tokenization to isolate the ADT identifier from surrounding data.

Column ID program 106 may determine suspected matches by using semantic analysis techniques on the entire text of the ADT identifier, the tokens into which the ADT identifier was broken, and/or the variations, combinations, and/or permutations of those tokens. Column ID program 106 may also use n-gram analysis in order to infer many related terms from a single term. For example, the unigram “phone” occurs in the context of the bigram “phone number” with a high TF/IDF frequency, so column ID program 106 can infer “work phone number,” “phone number,” and “work number” from “work phone.”

If column ID program 106 identifies only one suspected match (step 410), then that match is determined to be the ADT of the column (step 416).

Column ID program 106 may identify multiple suspected matches (step 410), in which case column ID program 106 narrows the results (step 414) by determining how closely the column data complies with the ADT pattern definition of each suspected match. The suspected match with which the column data most closely complies is determined to be the ADT of the column (step 416.)

In the event that the column data is equally compliant with the ADT pattern definition of more than one suspected match, then column ID program 106 may resolve the tie, for example, through additional context or by prompting a user for resolution. Alternatively, column ID program 106 may leave the tie unresolved, in which case it may associate the column with multiple ADTs, no ADTs, and/or an identifier indicating a tie. Additional context may include, for example, the ADTs of any other columns of the data set, as certain columns may be expected to co-occur within a data set (e.g., first names and last names), or a probabilistic analysis based on which ADT is more common.

If the patterns followed by the entries do not conform to any single ADT, then column ID program 106 may match multiple ADTs to a single column. Column ID program 106 may group entries with patterns in common, for example by moving entries to another column or by reordering the entries to make the group contiguous.

FIG. 5 depicts operational steps of comparison program 108 for comparing data sets, in accordance with an embodiment of the present invention.

Comparison program 108 receives a first data set from storefront program 104 (step 502). The first data set comprises a column having column data, metadata associated with the column identifying the data type of the column data, and the data set may comprise a header associated with the column, the header having header data. In an alternate embodiment, comparison program 108 receives the first data set from a client device.

Comparison program 108 receives a second data set from data store 112 (step 504), which may be received responsive to an instruction from comparison program 108. The second data set comprises a column having column data, metadata associated with the column identifying the data type of the column data, and the data set may comprise a header associated with the column, the header having header data. In an alternate embodiment, comparison program 108 receives the second data set from a client device.

Comparison program 108 compares the first and second data sets to generate a confidence score (step 506). The confidence score reflects the likelihood that the first and second data sets contain data of the same ADT. The confidence score may be determined by comparing the metadata of the first and second data sets.

Comparison program 108 determines if the confidence score exceeds a threshold (decision 508). The threshold may be a learned threshold, a fixed threshold, or user-provided threshold. The confidence score exceeding the threshold suggests that a column of the first data set and a column of the second data set both contain data of the same ADT.

In one embodiment, if the confidence score exceeds the threshold (YES branch, decision 508), comparison program 108 may receive user input from a user confirming or denying the match. The user may be a user associated with the first data set, a user associated with the second data set, another user, a moderator, or another party. Comparison program 108 may present a representation of the confidence score and/or a representation of whether the confidence score exceeds the threshold to the user. If the user input denies the match, then comparison program 108 follows the NO branch of decision 508. Comparison program 108 may use the user input to refine the confidence score model, for example by adjusting the threshold or by adjusting the confidence score determination process.

If the confidence score does not exceed the threshold (NO branch, decision 508), the comparison program skips steps 510 and 512 and ends. In an alternate embodiment, the comparison program presents the data types of the compared data sets to a user and receives input from the user identifying matches, in which case the comparison program ends if the user indicates there are no matches. In an alternate embodiment, comparison program 108 compares the first data set to a plurality of data sets.

If the confidence score exceeds the threshold (YES branch, decision 508), then a first column data and a second column data, each of respective data sets, are of the same ADT. Comparison program 108 compares the first and second column data to generate a relevancy score (step 510). The relevancy score may reflect the similarity of the first column data to the second column data, based upon, for example, the formatting of the first and second column data. The relevancy score may reflect analytics of purchase histories. For example, the relevancy score may be high for data sets which users frequently purchase together or frequently owned together, even if the ADTs of the data set do not match.

When comparing column data of a first data set to column data of a second data set, comparison program 108 uses a comparison method applicable to the ADT of the column data. The type of comparison performed depends upon the semantics of the ADT. For example, comparison program 108 may compare dates differently than it would names.

Comparison program 108 returns the relevancy score to storefront program 104 (step 512). In an alternate embodiment of step 512, comparison program 108 also returns a data set to storefront program 104, which may be the first data set, the second data set, or another data set.

A low confidence score (or a denial of a match by a user) suggests that the first data set and second data set do not contain compatible data. A high confidence score (or a manual match by a user) suggests the first data set and second data set contain compatible data. The relevancy score suggests whether it would be useful to merge the data of the first and second data sets.

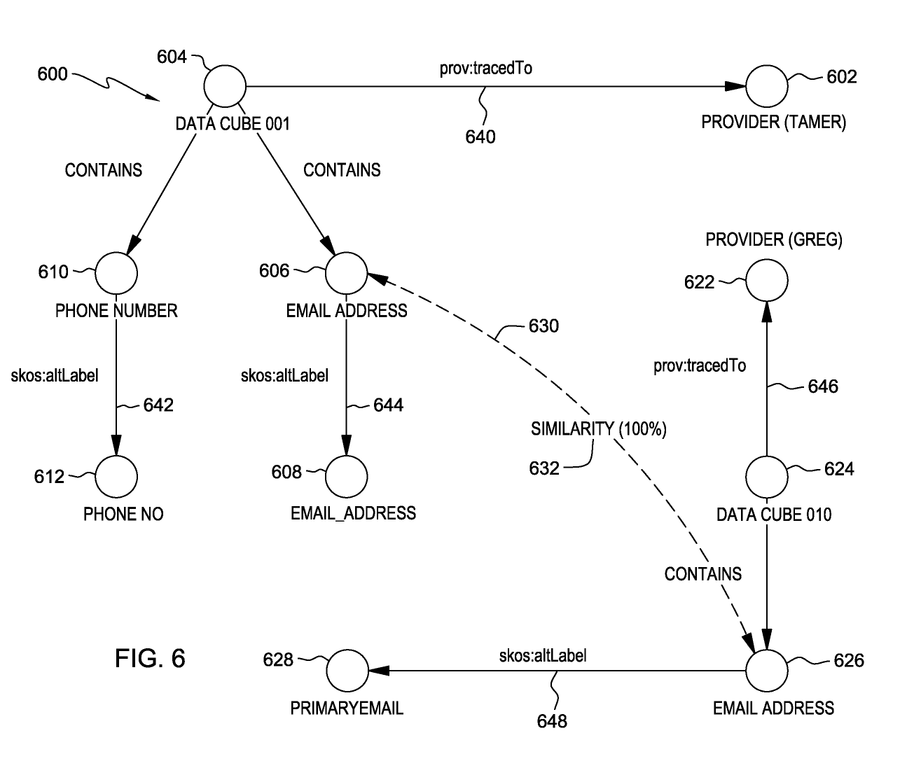

FIG. 6 depicts an implementation of correlating data sets, generally designated as 600, in accordance with an illustrative embodiment of the present invention. It should be appreciated that FIG. 6 provides only an illustration of one implementation and does not imply any limitations with regard to how the correlation of data sets may be implemented. Many modifications to the depicted implementation may be made.

In the illustrative embodiment of FIG. 6, first data set 604 is compared with second data set 622, including comparison 630 wherein column data 606 of first data set 604 is compared with column data 624 of second data set 622. Relevance score 632 is generated in response to comparison 630 of first data set 604 and second data set 622. In this illustrative embodiment, the ADT of each column of each data set has been determined.

First data set 604 is associated (arrow 640) with first user 602. First data set 604 comprises a column with column data 610 corresponding to a phone number. Column data 610 is associated (arrow 642) with header 612 identifying column data 610 as a phone number. First data set 604 further comprises a column with column data 606 corresponding to an email address. Column data 606 is associated (arrow 644) with header 608 identifying column data 606 as an email address.

Second data set 624 is associated (arrow 646) with second user 622. Second data set 624 comprises a column with column data 626 corresponding to an email address. Column data 626 is associated (arrow 648) with header 628 identifying column data 626 as an email address.

Comparison 630 compares first data set 604 with second data set 624. Comparison 630 may comprise comparing each header of first data set 604 (e.g., headers 612 and 608) with each header of second data set 624 (e.g., header 628) and determining that header 608 of first data set 604 matches header 628 of second data set 624. In this illustrative implementation, header 608 is slightly more generic than header 628, but both correspond to an email address and are thus compatible for comparison.

Alternatively, comparison 630 may comprise comparing the column data of each column of first data set 604 (e.g., column data 610 and 606) to the column data of each column of second data set 624 (e.g., column data 626).

Responsive to comparison 630, relevance score 632 is generated. In this illustrative embodiment, column data 606 of first data set 604 and column data 626 of second data set 624 are very similar by the criteria used by comparison 630, resulting in a high value of relevance score 632.

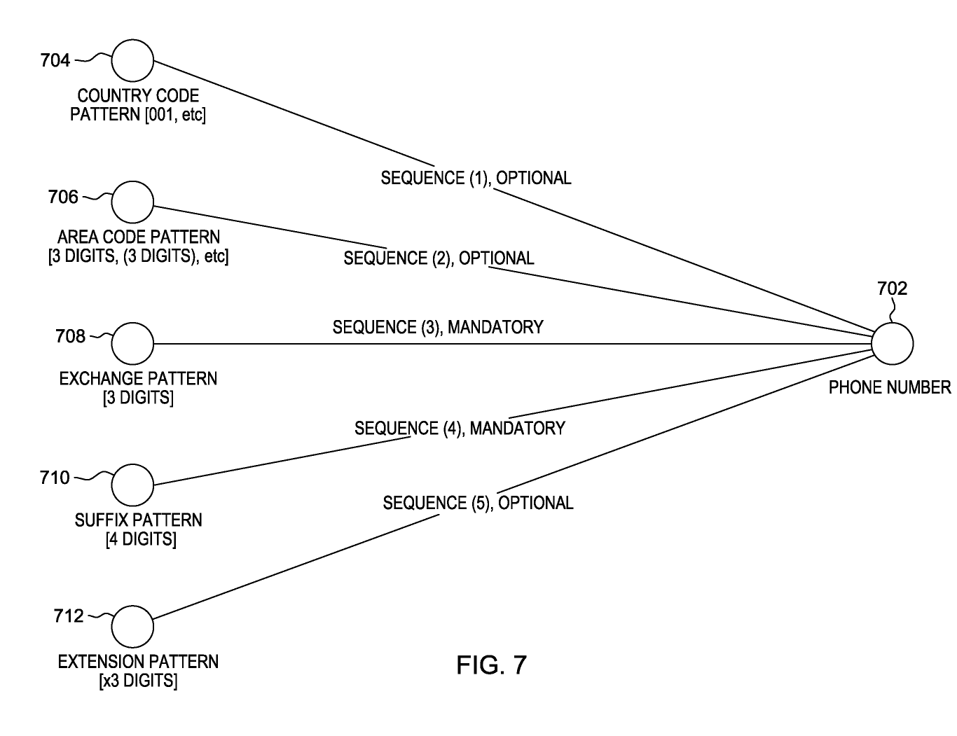

FIG. 7 depicts an implementation of a pattern definition of an ADT, in accordance with an illustrative embodiment of the present invention. It should be appreciated that FIG. 7 provides only an illustration of one implementation and does not imply any limitations with regard to the pattern definitions which may be implemented. Many modifications to the depicted pattern definition may be made.

Pattern definition 702 corresponds to an ADT corresponding to a United States phone number. Alternative embodiments consider various special forms of phone numbers, such as short codes (e.g., for emergency services or information).

In this implementation, pattern definition 702 comprises five sequences of characters. Only third sequence 708 and fourth sequence 710 are required; first sequence 704, second sequence 706 and fifth sequence 812 are optional.

First sequence 704 corresponds to a country code and is optional. If present, first sequence 704 must comprise between one and three numerical digits. Pattern definition 702 may include a list of valid country codes, in which case the digits of first sequence 704 must match one of the valid country codes. Pattern definition 702 may disregard leading zeroes in first sequence 704.

Second sequence 706 corresponds to an area code and is optional. If present, second sequence 706 must comprise three numerical digits. Pattern definition 702 may include a list of valid area codes, in which case the digits of second sequence 706 must match one of the valid area codes. In an alternate embodiment, second sequence 706 is mandatory only if first sequence 704 is present.

Third sequence 708 corresponds to an exchange and is mandatory. In this illustrative embodiment, third sequence 708 must comprise three numerical digits. In an embodiment, pattern definition 702 includes a list of valid exchanges and the numerical digits of third sequence 708 must match a listed exchange. In an alternate embodiment, each listed exchange corresponds to a listed area code, which must match the second sequence 704.

Fourth sequence 710 corresponds to a suffix and is mandatory. In this illustrative embodiment, fourth sequence 710 must comprise four numerical digits. In an alternate embodiment, third sequence 708 and/or fourth sequence 710 may comprise a combination of letters and numerical digits. For example, a phone number may be signified using a seven-letter word, each letter corresponding to a number on a telephone keypad. Contextual information may improve a confidence score when comparing such a seven-letter word to pattern definition 702, such as the presence of an area code in second sequence 706.

Fifth sequence 712 corresponds to an exchange and is optional. Fifth sequence 712 may begin with an extension delineator, such as the letter “x” in lower-case. Fifth sequence 712 may comprise one or more numerical digits following the extension delineator, if present. The number of digits allowed may vary in various embodiments.

Various delineators may precede or follow the sequences. For example, a plus symbol (“+”) may precede first sequence 704. Parentheses may surround second sequence 706. Dashes, periods (or dots), or spaces may separate some or all of the sequences.

FIG. 8 depicts a block diagram of components of server computer 102 in accordance with an illustrative embodiment of the present invention. It should be appreciated that FIG. 8 provides only an illustration of one implementation and does not imply any limitations with regard to the environments in which different embodiments may be implemented. Many modifications to the depicted environment may be made.

Server computer 102 includes communications fabric 802, which provides communications between computer processor(s) 804, memory 806, persistent storage 808, communications unit 810, and input/output (I/O) interface(s) 812. Communications fabric 802 can be implemented with any architecture designed for passing data and/or control information between processors (such as microprocessors, communications and network processors, etc.), system memory, peripheral devices, and any other hardware components within a system. For example, communications fabric 802 can be implemented with one or more buses.

Memory 806 and persistent storage 808 are computer-readable storage media. In this embodiment, memory 806 includes random access memory (RAM) 814 and cache memory 816. In general, memory 806 can include any suitable volatile or non-volatile computer-readable storage media.

Storefront program 104, column ID program 106, comparison program 108, and data store 112 are stored in persistent storage 808 for execution and/or access by one or more of the respective computer processors 804 via one or more memories of memory 806. In this embodiment, persistent storage 808 includes a magnetic hard disk drive. Alternatively, or in addition to a magnetic hard disk drive, persistent storage 808 can include a solid state hard drive, a semiconductor storage device, read-only memory (ROM), erasable programmable read-only memory (EPROM), flash memory, or any other computer-readable storage media that is capable of storing program instructions or digital information.

The media used by persistent storage 808 may also be removable. For example, a removable hard drive may be used for persistent storage 808. Other examples include optical and magnetic disks, thumb drives, and smart cards that are inserted into a drive for transfer onto another computer-readable storage medium that is also part of persistent storage 808.

Communications unit 810, in these examples, provides for communications with other data processing systems or devices, client devices 116 and 118. In these examples, communications unit 810 includes one or more network interface cards. Communications unit 810 may provide communications through the use of either or both physical and wireless communications links. Storefront program 104, column ID program 106, and comparison program 108 may be downloaded to persistent storage 808 through communications unit 810.

I/O interface(s) 812 allows for input and output of data with other devices that may be connected to server computer 102. For example, I/O interface 612 may provide a connection to external devices 818 such as a keyboard, keypad, a touch screen, and/or some other suitable input device. External devices 818 can also include portable computer-readable storage media such as, for example, thumb drives, portable optical or magnetic disks, and memory cards. Software and data used to practice embodiments of the present invention, e.g., storefront program 104, column ID program 106, and comparison program 108, can be stored on such portable computer-readable storage media and can be loaded onto persistent storage 808 via I/O interface(s) 812. I/O interface(s) 812 also connect to a display 820.

Display 820 provides a mechanism to display data to a user and may be, for example, a computer monitor.

The programs described herein are identified based upon the application for which they are implemented in a specific embodiment of the invention. However, it should be appreciated that any particular program nomenclature herein is used merely for convenience, and thus the invention should not be limited to use solely in any specific application identified and/or implied by such nomenclature.

The flowchart and block diagrams in the Figures illustrate the architecture, functionality, and operation of possible implementations of systems, methods and computer program products according to various embodiments of the present invention. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

What is claimed is:

1. A computer-implemented method for correlating data sets, the method comprising:
determining, by a computer system, for a first data set comprising one or more columns, each column comprising column data, a data type of the column data of a first column of the first data set;
identifying, by the computer system, a second column of a second data set associated with the data type;
comparing, by the computer system, the column data of the first and second columns and, in response, determining, by the computer system, a score representing a degree of relevance between the first and second data columns; and
determining, by the computer system, whether the score exceeds a threshold and, if so, suggesting, by the computer system, the second data set to a user.

2. The method of claim 1, wherein suggesting the second data set to the user comprises:
initiating to notify, by the computer system, the user of the second data set;
initiating to notify, by the computer system, the user of a sale price;
receiving, at the computer system, a payment corresponding to the sale price; and
initiating to send, from the computer system, the second data set to the user.

3. The method of claim 2, further comprising:
identifying, by the computer system, a second user associated with the second data set; and
allocating, by the computer system, at least some of the payment received to the second user.

4. The method of claim 1, wherein determining the data type of the column data of the first data column of the first data set comprises:
determining, by the computer system, a data pattern of the column data of the first column;
comparing, by the computer system, the data pattern to one or more formatting conventions of the data type, and, in response, determining, by the computer system, a second score representing the degree to which the data pattern complies with the one or more formatting conventions; and
determining, by the computer system, whether the second score exceeds a second threshold and, if so, associating the first column with the data type.

5. The method of claim 4, further comprising, prior to associating the first column with the data type:
presenting, by the computer system, the column data of the first column to the user;
presenting, by the computer system, the second score to the user; and
receiving, at the computer system, a user input confirming the data type.

6. The method of claim 4, further comprising, prior to associating the first column with the data type:
presenting, by the computer system, the column data of the first column to a second user;
presenting, by the computer system, the second score to the user; and
receiving, at the computer system, a user input confirming the data type.

7. The method of claim 1, wherein determining the data type of the first column of the first data set comprises:
determining, by the computer system, a column name of the first column;
determining, by the computer system, that the column name matches a name of the data type; and
associating, by the computer system, the first column with the data type.

8. The method of claim 7, further comprising, prior to associating the first column with the data type:
determining, by the computer system, a data pattern of the column data of the first column; and
comparing, by the computer system, the data pattern to one or more formatting conventions of the data type and, in response, determining, by the computer system, that the data pattern complies with the one or more formatting conventions.

9. A computer program product for correlating data sets, the computer program product comprising:
one or more computer-readable storage media and program instructions stored on the one or more computer-readable storage media, the program instructions comprising:
program instructions to determine, for a first data set comprising one or more columns, each column comprising column data, a data type of the column data of a first column of the first data set;
program instructions to identify a second column of a second data set associated with the data type;
program instructions to compare the column data of the first and second columns and, in response, determine a score representing a degree of relevance between the first and second data columns; and
program instructions to determine whether the score exceeds a threshold and, if so, suggest the second data set to a user.

10. The computer program product of claim 9, wherein the program instructions to suggest the second data set to the user comprises:
program instructions to initiate to notify the user of the second data set;
program instructions to initiate to notify the user of a sale price;
program instructions to receive a payment corresponding to the sale price; and
program instructions to initiate to send the second data set to the user.

11. The computer program product of claim 10, further comprising:
program instructions to identify a second user associated with the second data set; and
program instructions to allocate at least some of the payment received to the second user.

12. The computer program product of claim 9, wherein the program instructions to determine the data type of the column data of the first column of the first data set comprises:
program instructions to determine a data pattern of the column data of the first column;
program instructions to compare the data pattern to one or more formatting conventions of the data type, and, in response, determine a second score representing the degree to which the data pattern complies with the one or more formatting conventions; and
program instructions to determine whether the second score exceeds a second threshold and, if so, associate the first column with the data type.

13. The computer program product of claim 12, further comprising, prior to the program instructions to associate the first column with the data type:
program instructions to present the column data of the first column to the user;
program instructions to present the second score to the user; and
program instructions to receive a user input confirming the data type.

14. The computer program product of claim 9, wherein the program instructions to determine the data type of the column data of the first column of the first data set comprises:
program instructions to determine a column name of the first column;
program instructions to determine that the column name matches a name of the data type; and
program instructions to associate the first column with the data type.

15. A computer system for correlating data sets, the computer system comprising:
one or more computer processors;
one or more computer-readable storage media;
program instructions to determine, for a first data set comprising one or more columns, each column comprising column data, a data type of the column data of a first column of the first data set;
program instructions to identify a second column of a second data set associated with the data type;
program instructions to compare the column data of the first and second columns and, in response, determine a score representing a degree of relevance between the first and second data columns; and
program instructions to determine whether the score exceeds a threshold and, if so, suggest the second data set to a user.

16. The computer system of claim 15, wherein the program instructions to suggest the second data set to the user comprises:
program instructions to initiate to notify the user of the second data set;
program instructions to initiate to notify the user of a sale price;
program instructions to receive a payment corresponding to the sale price; and
program instructions to initiate to send the second data set to the user.

17. The computer system of claim 16, further comprising:
program instructions to identify a second user associated with the second data set; and
program instructions to allocate at least some of the payment received to the second user.

18. The computer system of claim 15, wherein the program instructions to determine the data type of the column data of the first column of the first data set comprises:
program instructions to determine a data pattern of the column data of the first column;
program instructions to compare the data pattern to one or more formatting conventions of the data type, and, in response, determine a second score representing the degree to which the data pattern complies with the one or more formatting conventions; and
program instructions to determine whether the second score exceeds a second threshold and, if so, associate the first column with the data type.

19. The computer system of claim 18, further comprising, prior to the program instructions to associate the first column with the data type:
program instructions to present the column data of the first column to the user;
program instructions to present the second score to the user; and
program instructions to receive a user input confirming the data type.

20. The computer system of claim 15, wherein the program instructions to determine the data type of the column data of the first column of the first data set comprises:
program instructions to determine a column name of the first column;
program instructions to determine that the column name matches a name of the data type; and
program instructions to associate the first column with the data type.
